(19) United States
(12) Patent Application Publication
(10) Pub. No.: US 2026/0370486 A1
(43) Pub. Date: Nov. 19, 2026

(54) DATA MANAGEMENT APPARATUS, DATA MANAGEMENT METHOD, AND DATA MANAGEMENT PROGRAM

(71) Applicant: NEC Corporation, Tokyo (JP)

(72) Inventor: Yoshiyuki OHNO, Tokyo (JP)

(73) Assignee: NEC Corporation, Tokyo (JP)

(21) Appl. No.: 19/657,180

(22) Filed: Apr. 24, 2026

(30) Foreign Application Priority Data
May 14, 2025 (JP) 2025-080866

(51) Int. Cl. H04L 9/32

(52) U.S. Cl. CPC H04L 9/3236

(57) ABSTRACT

A data management apparatus including a management unit configured to manage data using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

### CROSS-REFERENCE TO RELATED APPLICATION

This application is based upon and claims the benefit of priority from the prior Japanese Patent Application No. 2025-080866, filed May 14, 2025, the entire contents of which are incorporated herein by reference.

### BACKGROUND OF INVENTION

### Field of the Invention

The present disclosure relates to a data management apparatus, a data management method, and a data management program.

### Description of the Related Art

Patent literature 1 (paragraph 0109) describes an example of a hash table. In this hash table, pieces of connection information having a same hash value are associated with each other.
[Patent literature 1] Japanese Unexamined Patent Application Publication No. 2015-177263

### SUMMARY OF INVENTION

However, in the hash table described in Patent literature 1, it is necessary to manage arrays for the number of hash values, and there is a problem in that, when expansion of those arrays occurs frequently, a cost required for memory management increases.

The present disclosure has been made in view of these problems. An example object of the present disclosure is to provide a data management apparatus, a data management method, and a data management program capable of reducing memory management cost.

A data management apparatus according to an example aspect of the present disclosure includes a management unit configured to manage data using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

A data management method according to an example aspect of the present disclosure includes managing data using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

A data management program according to an example aspect of the present disclosure causes a computer to execute management processing for managing data using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

According to the present disclosure, it is possible to reduce memory management cost.

### BRIEF DESCRIPTION OF THE DRAWINGS

FIG. 1A It is an explanatory diagram illustrating a structure of a hash table.

FIG. 1B It is an explanatory diagram illustrating a structure of a hash table.

FIG. 2 It is a block diagram illustrating a functional configuration of a data management apparatus.

FIG. 3 It is a flowchart illustrating an operation of the data management apparatus.

FIG. 4 It is a flowchart illustrating an operation of the data management apparatus.

FIG. 5 It is an explanatory diagram illustrating an outline of an operation of the data management apparatus.

FIG. 6 It is an explanatory diagram illustrating an outline of an operation of the data management apparatus.

FIG. 7 It is a block diagram illustrating a hardware configuration of a computer.

FIG. 8 It is a block diagram illustrating a principal part of the data management apparatus.

FIG. 9 It is an explanatory diagram illustrating Join processing and GroupBy processing for table data.

FIG. 10A It is an explanatory diagram illustrating a general hash table.

FIG. 10B It is an explanatory diagram illustrating a general hash table.

FIG. 11 It is an explanatory diagram illustrating a structure of a general hash table.

FIG. 12 It is an explanatory diagram illustrating a structure of a general hash table.

FIG. 13 It is an explanatory diagram illustrating a structure of a general hash table.

FIG. 14 It is an explanatory diagram illustrating a structure of a general hash table.

### DESCRIPTION OF THE PREFERRED EMBODIMENTS

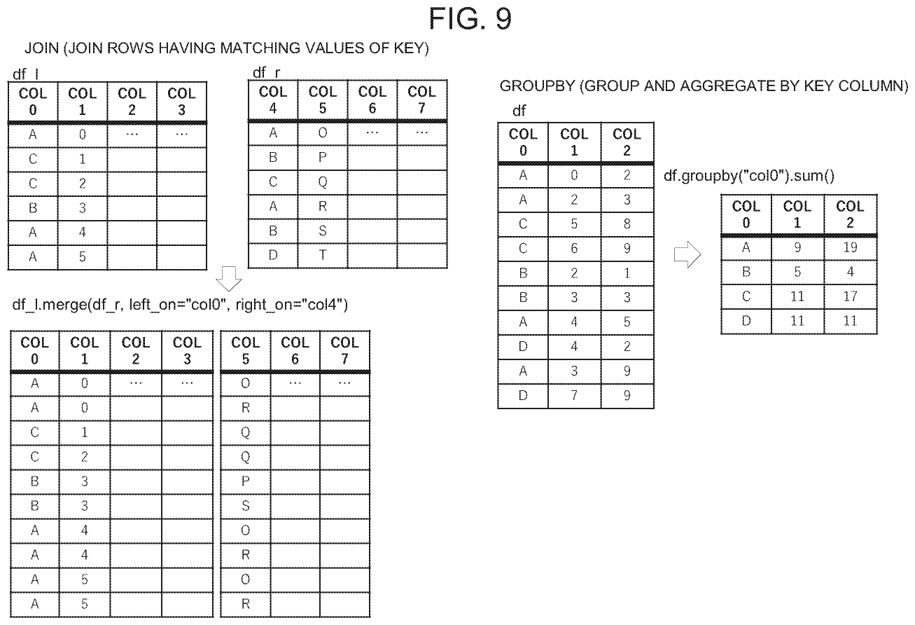

The following explains general Join processing and GroupBy processing for table data. FIG. 9 is an explanatory diagram illustrating Join processing and GroupBy processing for table data.

On a left side of FIG. 9, an example of Join processing is shown in which rows having matching values of Key (hereinafter, also referred to as a key) are joined between a data table df_l and a data table df_r. It should be noted that values of Key are stored in a column col0 in the data table df_l and in a column col4 in the data table df_r before the Join processing. In both the data table df_l and the data table df_r, a plurality of rows associated with a same Key may exist.

On a right side of FIG. 9, an example of GroupBy processing is shown in which a data table df is grouped for each Key column and aggregation is performed for each group. It should be noted that a value of Key is stored in a column col0 in the data table df. In the data table df before the GroupBy processing, a plurality of rows associated with a same Key may exist.

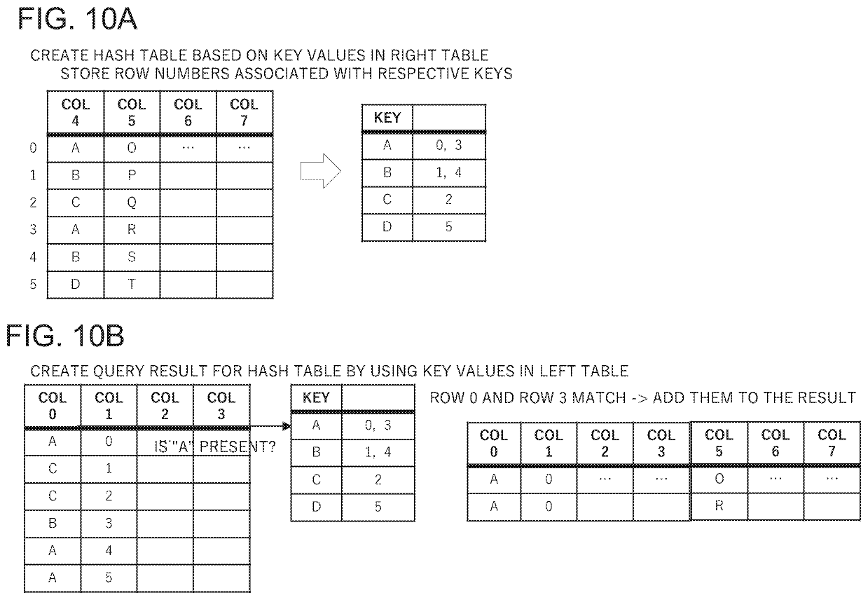

Next, the following explains a hash table used for the Join processing and the GroupBy processing shown in FIG. 9. FIGS. 10A and 10B are explanatory diagrams illustrating a general hash table. A hash table is a data structure that stores a plurality of sets of a Key and a value (hereinafter, also referred to as entries) and enables a value associated with a Key to be referred to. A hash table is also referred to as a hash map. Such a hash table is also used to efficiently achieve Join processing and GroupBy processing.

FIG. 10A shows an example in which a hash table is created based on values of Key in the data table df_r shown in FIG. 9. In the hash table of FIG. 10A, row numbers of the data table df_r associated with the respective Keys, that is, table indexes, are stored. It should be noted that a plurality of row numbers are associated with a same Key.

FIG. 10B shows an example of processing for creating a query result by using the hash table of FIG. 10A in response to a query based on values of the Key column of the data table df_l shown in FIG. 9. Specifically, a query, that is, a search, based on a Key value “A” is performed, and rows having a Key that matches “A” in the data table df_l, that is, row 0 and row 3, are extracted as the query result, that is, a search result.

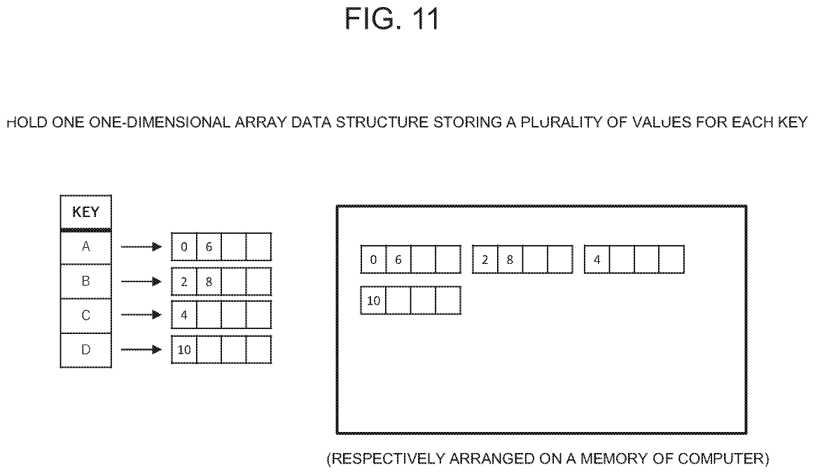

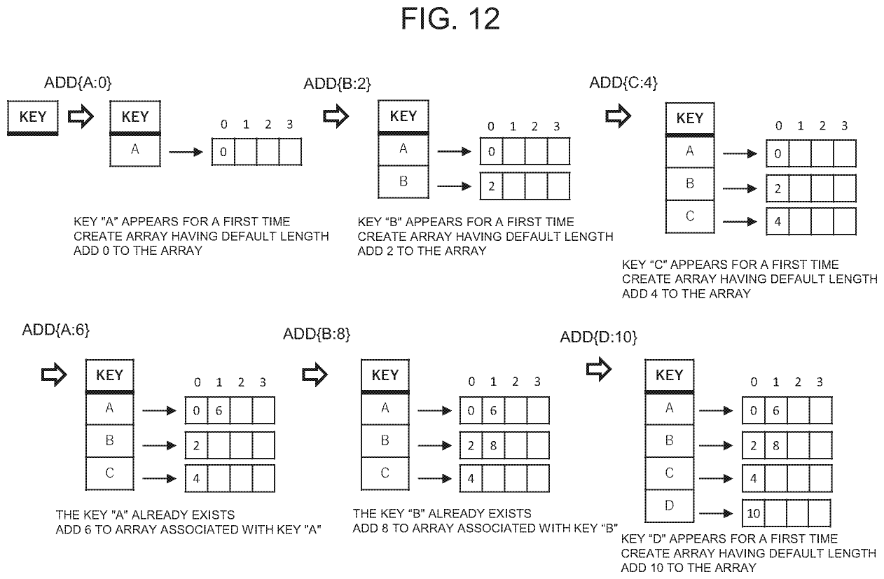

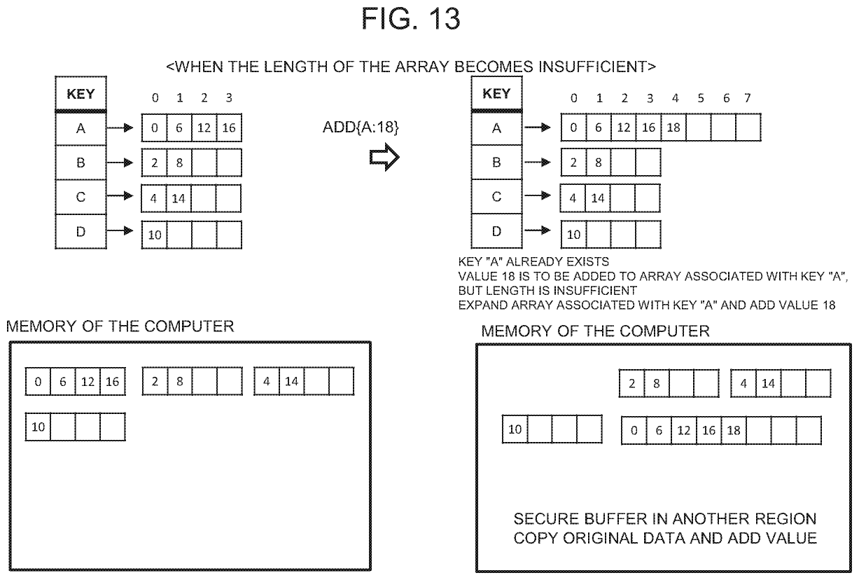

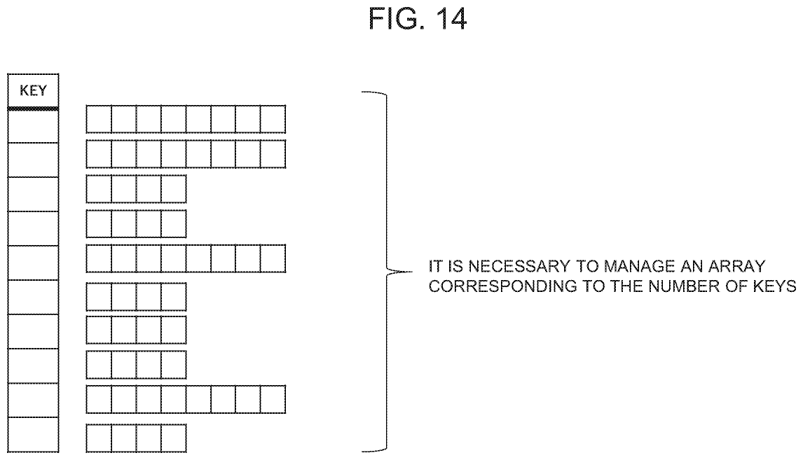

FIG. 11, FIG. 12, FIG. 13, and FIG. 14 are explanatory diagrams illustrating structures of general hash tables. On a left side of FIG. 11, a structure of a general hash table is shown. This hash table has a configuration in which one one-dimensional array data structure capable of storing a plurality of values is held for each Key. That is, a set of values associated with a Key is held as an array. On a right side of FIG. 11, a manner in which the respective arrays of the hash table are arranged on a memory of a computer is illustrated. Here, a state is visually shown in which one-dimensional arrays associated with the respective Keys, that is, continuous memory regions, are respectively arranged on the memory.

FIG. 12 is an explanatory diagram illustrating an outline of an operation of the general hash table shown in FIG. 11. An upper left part of FIG. 12 shows an initial state in which no entry has yet been stored in the hash table.

In the example of FIG. 12, in the initial state, an entry {A:0} having a Key “A” and a value “0” is added. The Key “A” is a Key that appears in the hash table for a first time. Therefore, an array associated with the Key “A” is newly created. This array has a predetermined length, that is, four elements in this example. The value “0” is stored in a first element of this array, that is, at a position of index 0.

Next, an entry {B:2} having a Key “B” and a value “2” is added. The Key “B” is a Key that appears in the hash table for a first time. Therefore, an array associated with the Key “B” is newly created. This array has a predetermined length, that is, four elements in this example. The value “2” is stored in a first element of this array, that is, at a position of index 0.

Next, an entry {C:4} having a Key “C” and a value “4” is added. The Key “C” is a Key that appears in the hash table for a first time. Therefore, an array associated with the Key “C” is newly created. This array has a predetermined length, that is, four elements in this example. The value “4” is stored in a first element of this array, that is, at a position of index 0.

Next, an entry {A:6} having a Key “A” and a value “6” is added. The Key “A” is a Key that already exists in the hash table. Therefore, the value “6” is added to the array associated with the Key “A”. Specifically, the value “6” is stored in a first unused element, that is, at a position of index 1, among unused elements in which no value is stored in this array, hereinafter also referred to as unused elements.

Next, an entry {B:8} having a Key “B” and a value “8” is added. The Key “B” is a Key that already exists in the hash table. Therefore, the value “8” is added to the array associated with the Key “B”. Specifically, the value “8” is stored in a first element, that is, at a position of index 1, among unused elements of this array.

Finally, an entry {D:10} having a Key “D” and a value “10” is added. The Key “D” is a Key that appears in the hash table for a first time. Therefore, an array associated with the Key “D” is newly created. This array has a predetermined length, that is, four elements in this example. The value “10” is stored in a first element of this array, that is, at a position of index 0.

FIG. 13 is an explanatory diagram illustrating an outline of an operation of the hash table shown in FIG. 11. FIG. 13 illustrates an operation when a length of an array becomes insufficient.

Specifically, a left part of FIG. 13 shows a state in which values are stored in all elements of an array associated with the Key “A”. It should be noted that an initial length of this array is four elements. The following explains a case in which an entry {A:18} having a Key “A” and a value “18” is added in this state.

Because the Key “A” already exists in the hash table, it is necessary to add the value “18” to the associated array. However, no unused element exists in this array. Therefore, array expansion processing is executed. Then, the value “18” is added to the expanded array. Specifically, the value “18” is stored in a first element, that is, at a position of index 4, among unused elements of this array.

In this expansion processing, on a memory of the computer, a buffer for arranging a new array after expansion is secured in another region different from a region in which an existing array associated with the Key “A” is arranged. Next, all elements of the existing array are copied to the new array. Thereafter, the value “18” is added to the new array. It should be noted that a size used when an array is expanded can be set arbitrarily, but generally, a configuration is often adopted in which an existing array length is doubled.

FIG. 14 is an explanatory diagram showing a problem of the hash table shown in FIG. 11. As shown in FIG. 14, in a general hash table, it is necessary to individually manage arrays for the respective Keys. Therefore, when the number of Keys increases, the number of arrays also increases in proportion to the number of Keys. Further, when expansion processing frequently occurs in the respective arrays, it becomes necessary to secure and relocate memory regions, and thus there is a problem in that a cost required for memory management increases. It should be noted that, in order to suppress a frequency of the expansion processing, a configuration may be considered in which a large array size is secured in advance. In this case, however, many elements become unused, and memory utilization efficiency decreases, and therefore it becomes difficult to perform efficient memory management.

The following explains example embodiments of the present disclosure with reference to the drawings. In the respective drawings, identical reference signs are assigned to same or related elements, and repeated explanation is omitted as appropriate for clarity of explanation. Unless otherwise explained, predetermined values such as threshold values are stored in advance in a storage device or the like accessible from an apparatus that uses the values. Unless otherwise explained, a storage unit is configured by one or more storage devices.

### Example Embodiment 1

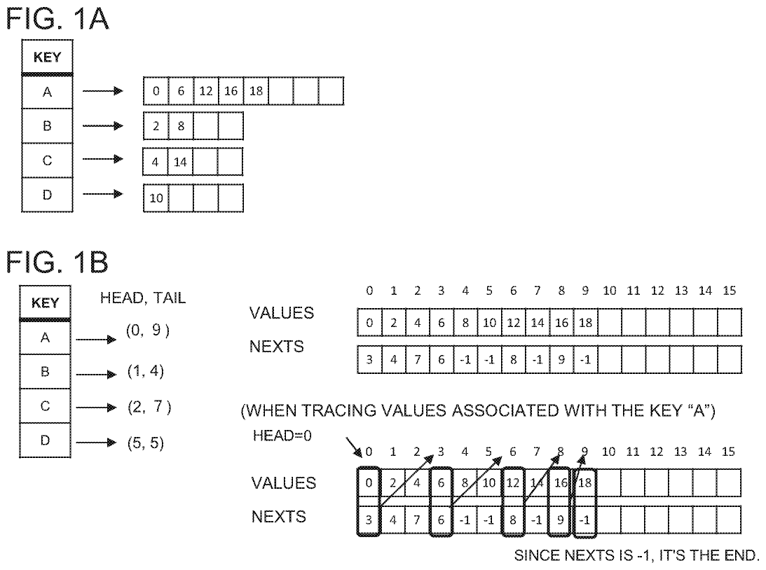

A data management apparatus 100 of the present example embodiment has a function of managing data by using a hash table. FIGS. 1A and 1B are explanatory diagrams illustrating a structure of a hash table. FIG. 1A shows a general hash table after array expansion processing shown in a right part of FIG. 13. In the example of FIG. 1A, values associated with a key “A” are five values 0, 6, 12, 16, and 18, and a sequence of the values is managed in an order of 0->6->12->16->18.

In contrast, FIG. 1B illustrates a hash table used by the data management apparatus 100 of the present example embodiment. It should be noted that, in the example of FIG. 1, the hash table shown in FIG. 1A and the hash table shown in FIG. 1B both store identical sets of Keys and values.

As shown in FIG. 1B, the hash table used by the data management apparatus 100 of the present example embodiment has a configuration in which, for each Key, associated head information, hereinafter also referred to as first information, and tail information, hereinafter also referred to as second information, are held. Further, this hash table has a configuration in which an array that collectively stores one or more values associated with each of a plurality of keys, hereinafter also referred to as a values array or a first array, and an array having elements in one-to-one association with elements of the values array and storing information indicating a storage location of a next value associated with a same key, hereinafter also referred to as a nexts array or a second array, are held.

The head information is information indicating a storage location of a first value among values associated with a Key. The tail information is information indicating a storage location of a last value among values associated with a Key. Here, “information indicating a storage location” specifically means an index in the values array.

In the example of FIG. 1B, head information associated with the Key “A” is “0”, and tail information is “9”. That is, this indicates that, among values associated with the Key “A”, a first value is stored in an element of the values array having index “0”, and a last value is stored in an element of the values array having index “9”. Similarly, head information associated with the Key “B” is “1”, and tail information is “4”. Accordingly, it can be understood that, among values associated with the Key “B”, a first value is stored in an element of the values array having index “1”, and a last value is stored in an element of the values array having index “4”.

As described above, in the present example embodiment, values associated with all keys managed by the hash table are collectively stored in a single values array. In other words, instead of preparing an individual array for each key, all keys share one values array.

The values array and the nexts array are associated with each other in a one-to-one manner through a same index. Hereinafter, an element associated with an index “i” of the values array is also denoted as values[i]. Further, an element associated with an index “i” of the nexts array is also denoted as nexts[i].

The nexts[i] stores information, that is, an index, indicating a storage location in the values array at which a next value associated with a same Key as a value stored in values[i] is stored. It should be noted that, when no subsequent value exists, a specific value indicating that a next value is not stored, that is, an end, is stored in nexts[i], and in the present example embodiment, the specific value is “−1”.

In the example of FIG. 1B, “0” is stored in values[0], and “3” is stored in associated nexts[0]. Further, “6” is stored in values[3]. Accordingly, it can be understood that a next value following the value “0” is “6”.

The following explains a procedure for acquiring values associated with the Key “A” in the example of FIG. 1B. The head information of the Key “A” is “0”. Therefore, the value “0” stored in values[0] is acquired as a first value. Next, when nexts[0] is referred to, “3” is obtained, and therefore the value “6” stored in values[3] is acquired as a next value.

Next, when nexts[3] is referred to, “6” is obtained, and therefore the value “12” stored in values[6] is acquired. Next, when nexts[6] is referred to, “8” is obtained, and therefore the value “16” stored in values[8] is acquired. Next, when nexts[8] is referred to, “9” is obtained, and therefore the value “18” stored in values[9] is acquired. Finally, when nexts[9] is referred to, “−1” is obtained, and therefore it can be determined that no subsequent value exists.

As described above, the values associated with the Key “A” are acquired in a chained manner in an order of 0->6->12->16->18.

### Explanation of Configuration

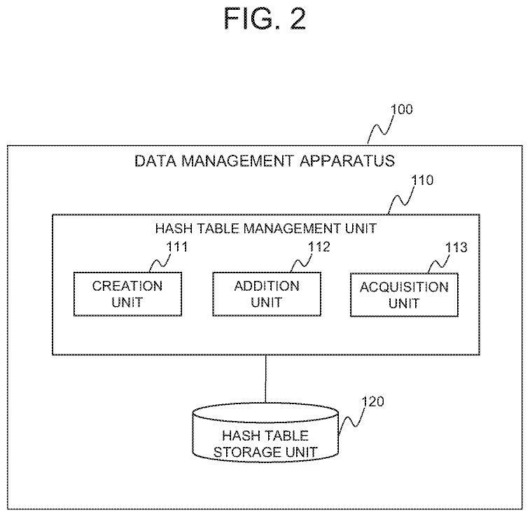

The following explains a functional configuration of the data management apparatus of the present example embodiment. FIG. 2 is a block diagram illustrating a functional configuration of the data management apparatus.

The data management apparatus 100 includes a hash table management unit 110 and a hash table storage unit 120. The hash table management unit 110 includes a creation unit 111, an addition unit 112, and an acquisition unit 113.

The hash table management unit 110 has a function of managing data by using a hash table. Specifically, the hash table management unit 110 executes various kinds of processing related to creation of the hash table, addition of data, and acquisition of data.

The hash table storage unit 120 is a main storage device for storing the hash table. The hash table storage unit 120 is implemented by using, for example, RAM (Random Access Memory).

When receiving a creation request for a hash table, the hash table management unit 110 executes creation processing for the hash table by using the creation unit 111.

The creation unit 111 has a function of creating a hash table that holds the above-described values array and nexts array and head information and tail information associated with each Key. For example, in response to the creation request, the creation unit 111 secures, on the hash table storage unit 120, a memory region having a predetermined initial size. The secured region includes a region for storing the values array and the nexts array and a region for storing the head information and the tail information. It should be noted that initial sizes of the values array and the nexts array can be set arbitrarily. For example, when the number of elements to be registered in the hash table is known in advance, the initial size may be set to an initial size associated with the number of elements.

When receiving an addition request for a set of a Key and a value for the hash table, the hash table management unit 110 executes addition processing of data by using the addition unit 112.

The addition unit 112 has a function of adding the set of the Key and the value in the addition request to the hash table.

For example, when receiving the addition request, the addition unit 112 acquires an effective length of the values array at a time of the reception, that is, the effective length corresponds to the number of used elements. When no value is stored in any element of the values array, the effective length of the values array is 0. When values are stored in x elements of the values array, the effective length of the values array is x. The effective length of the values array acquired here corresponds to an index indicating a first-position element among unused elements of the values array, that is, an element in which a value can next be stored. Further, the values array and the nexts array are associated with each other in a one-to-one manner through a same index. Therefore, for both the values array and the nexts array, the addition unit 112 can acquire an index indicating a first-position element among unused elements, hereinafter also referred to as a leading index of an unused element.

When the effective length of the values array has reached a capacity of the values array, that is, when no newly storable element exists, the addition unit 112 executes expansion processing for the values array and the nexts array.

In the expansion processing, on a memory of the computer, the addition unit 112 secures a buffer for arranging a new values array and a new nexts array after expansion in another region different from a region in which the existing values array and nexts array are arranged. Next, the addition unit 112 copies all elements of the existing values array and nexts array to the expanded values array and nexts array arranged in the newly secured region. It should be noted that sizes of the arrays after expansion can be set arbitrarily, and, for example, a setting in which the arrays are expanded to double the existing size or a setting in which the arrays are expanded at a fixed rate may be adopted.

The addition unit 112 determines whether a Key to be added already exists in the hash table, that is, whether the Key has already been registered. When the Key does not exist, that is, when the Key has not been registered, the addition unit 112 sets both the head information and the tail information associated with the Key to the leading index of an unused element. Further, the addition unit 112 stores a value to be added in a first-position element among unused elements in the values array. Further, the addition unit 112 stores a specific value indicating an end, that is, −1, in a first-position element among unused elements in the nexts array.

On the other hand, when the Key exists, that is, when the Key has already been registered, the addition unit 112 refers to the tail information associated with the Key and acquires an index indicating an element in the values array in which a last value associated with the Key is stored. Subsequently, the addition unit 112 updates information stored in an element of the nexts array associated with the acquired index to a leading index of an unused element of the values array. As a result, the information stored in the element of the nexts array is updated from the specific value indicating an end, that is, −1, to a leading index of an unused element of the values array, that is, an index indicating an element in which a value to be added is stored.

Next, the addition unit 112 updates the tail information associated with the Key to the leading index of the unused element of the values array. As a result, the tail information is updated to the leading index of the unused element of the values array, that is, an index indicating an element in which the value to be added is stored.

Thereafter, the addition unit 112 stores the value to be added in a first-position element among unused elements in the values array. Further, the addition unit 112 stores the specific value indicating an end, that is, −1, in a first-position element among unused elements in the nexts array.

When receiving a data acquisition request, for example, an acquisition request including a Key associated with a value to be acquired, the hash table management unit 110 executes data acquisition processing by using the acquisition unit 113.

The acquisition unit 113 has a function of acquiring a value associated with a specific key from the hash table.

For example, when receiving the acquisition request, the acquisition unit 113 refers to head information associated with a key included in the acquisition request and acquires an index indicating an element in which a first value associated with the Key is stored.

Thereafter, the acquisition unit 113 refers to an element of the values array associated with the acquired index and acquires a value stored in the element. Subsequently, the acquisition unit 113 refers to an element of the nexts array associated with the same index and acquires an index indicating an element in the values array in which a next value associated with the same key is stored. The acquisition unit 113 repeats similar processing unless the index acquired from the nexts array is the specific value indicating an end, that is, −1. By repeating these processing operations, all values associated with the Key are acquired in a chained manner.

It should be noted that the data management apparatus 100 is not limited to the configuration shown in FIG. 2. For example, the creation unit 111 may be provided independently of the hash table management unit 110. Further, FIG. 2 shows one example of a functional configuration of the data management apparatus 100, and the number, arrangement, connection form, and the like of the respective constituent elements can be changed as appropriate without departing from a gist of the present disclosure.

### Explanation of Operation

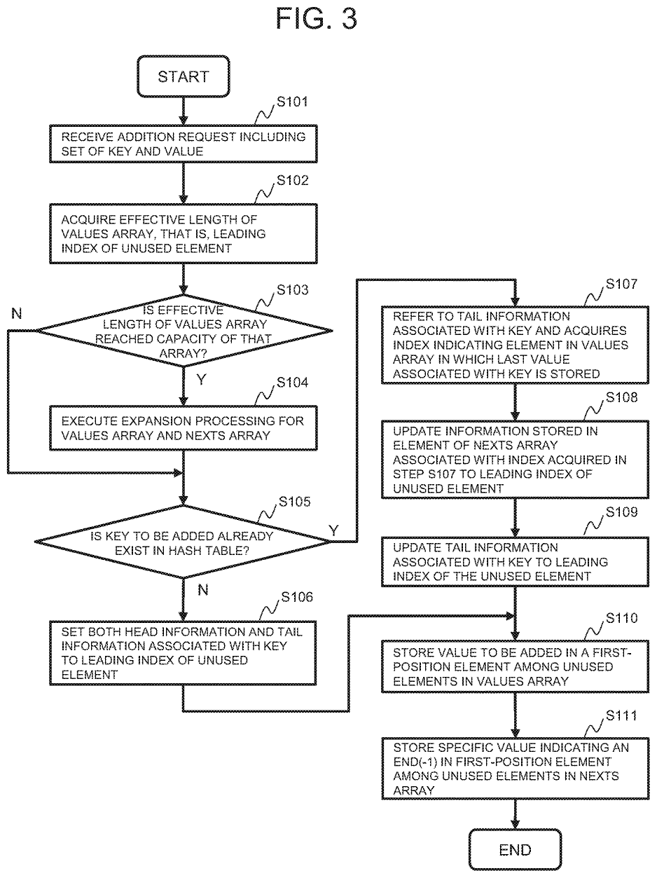

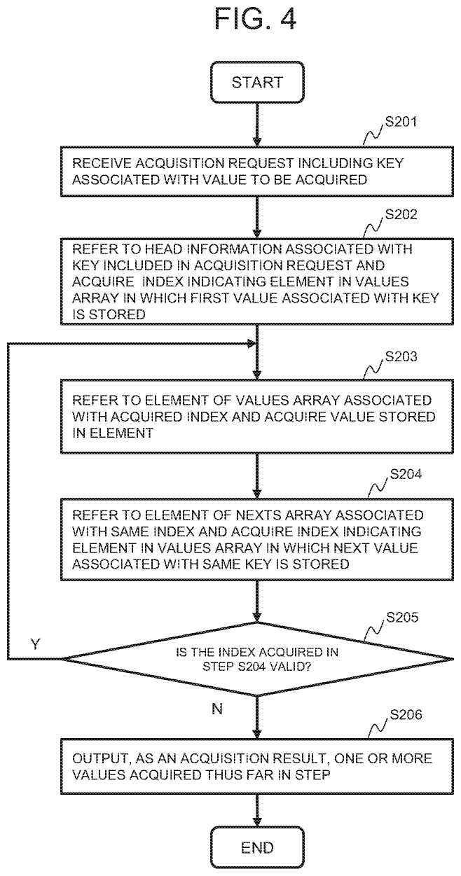

Next, the following explains an operation of the data management apparatus 100. FIG. 3 and FIG. 4 are flowcharts illustrating an operation of the data management apparatus 100.

First, the following explains data addition processing. FIG. 3 shows one example of the data addition processing. The hash table management unit 110 receives an addition request including a set of a Key and a value to be added to the hash table (step S101).

When receiving the addition request, the addition unit 112 acquires an effective length of the values array at the reception time, that is, a leading index of an unused element (step S102).

Next, the addition unit 112 determines whether the effective length of the values array has reached a capacity of the values array (step S103). When the effective length of the values array has not reached the capacity of the values array, the processing proceeds to step S105.

On the other hand, when the effective length of the values array has reached the capacity of the values array, the addition unit 112 executes expansion processing for the values array and the nexts array (step S104). Thereafter, the processing proceeds to step S105.

In step S105, the addition unit 112 determines whether the Key to be added already exists in the hash table, that is, whether the Key to be added has already been registered.

When it is determined in step S105 that the Key to be added does not exist in the hash table, the addition unit 112 sets both head information and tail information associated with the Key to the leading index of the unused element (step S106).

Next, the addition unit 112 stores the value to be added in a first-position element among unused elements in the values array (step S110). Further, the addition unit 112 stores the specific value indicating an end, that is, −1, in a first-position element among unused elements in the nexts array (step S111). Thereafter, the data addition processing ends.

When it is determined in step S105 that the Key to be added exists in the hash table, the addition unit 112 refers to tail information associated with the Key and acquires an index indicating an element in the values array in which a last value associated with the Key is stored (step S107).

Next, the addition unit 112 updates information stored in an element of the nexts array associated with the index acquired in step S107 to the leading index of the unused element of the values array acquired in step S102 (step S108). When the processing of step S108 is executed, the information stored in the element of the nexts array is updated from the specific value indicating an end, that is, −1, to the leading index of the unused element of the values array, that is, an index indicating an element in which the value to be added is stored.

Next, the addition unit 112 updates the tail information associated with the Key to the leading index of the unused element of the values array (step S109). When the processing of step S109 is executed, the tail information is updated to the leading index of the unused element of the values array, that is, an index indicating an element in which the value to be added is stored.

Next, the addition unit 112 stores the value to be added in a first-position element among unused elements in the values array (step S110). Further, the addition unit 112 stores the specific value indicating an end, that is, −1, in a first-position element among unused elements in the nexts array (step S111). Thereafter, the data addition processing ends.

Next, the following explains data acquisition processing. FIG. 4 shows one example of the data acquisition processing. The hash table management unit 110 receives an acquisition request including a Key associated with a value to be acquired (step S201).

When receiving the acquisition request, the acquisition unit 113 refers to head information associated with the key included in the acquisition request and acquires an index indicating an element in the values array in which a first value associated with the Key is stored (step S202).

Next, the acquisition unit 113 refers to an element of the values array associated with the index acquired in step S202 or step S204 explained later and acquires a value stored in the element (step S203).

Next, the acquisition unit 113 refers to an element of the nexts array associated with the same index and acquires an index indicating an element in the values array in which a next value associated with the same key is stored (step S204).

Next, the acquisition unit 113 determines whether the index acquired in step S204 is valid (step S205). Here, the acquisition unit 113 determines that the index is valid when the index acquired in step S204 is not the specific value indicating an end, that is, −1, and determines that the index is invalid when the index is the specific value, that is, −1.

When it is determined in step S205 that the index is valid, the processing returns to step S203 and acquires a next value. In the data acquisition processing shown in FIG. 4, all values associated with the Key included in the acquisition request are acquired in a chained manner by repeating the processing operations of steps S203 to S205 until it is determined in step S205 that the index is invalid.

On the other hand, when it is determined in step S205 that the index is invalid, the acquisition unit 113 outputs, as an acquisition result, one or more values acquired thus far in step S203. Thereafter, the data acquisition processing ends.

It should be noted that the operation examples shown in FIG. 3 and FIG. 4 do not limit the operation of the data management apparatus 100. For example, the data management apparatus 100 may have a configuration in which the processing operations of step S106 or steps S107 to S109 and the processing operations of steps S110 to S111 are executed in a reverse order or are executed in parallel. Further, the data management apparatus 100 may have a configuration in which the processing of step S203 and the processing of step S204 are executed in a reverse order or are executed in parallel.

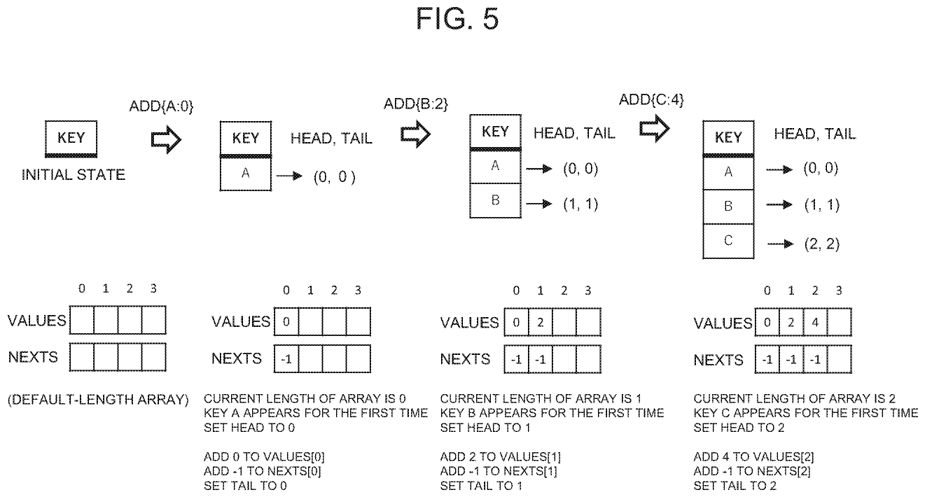

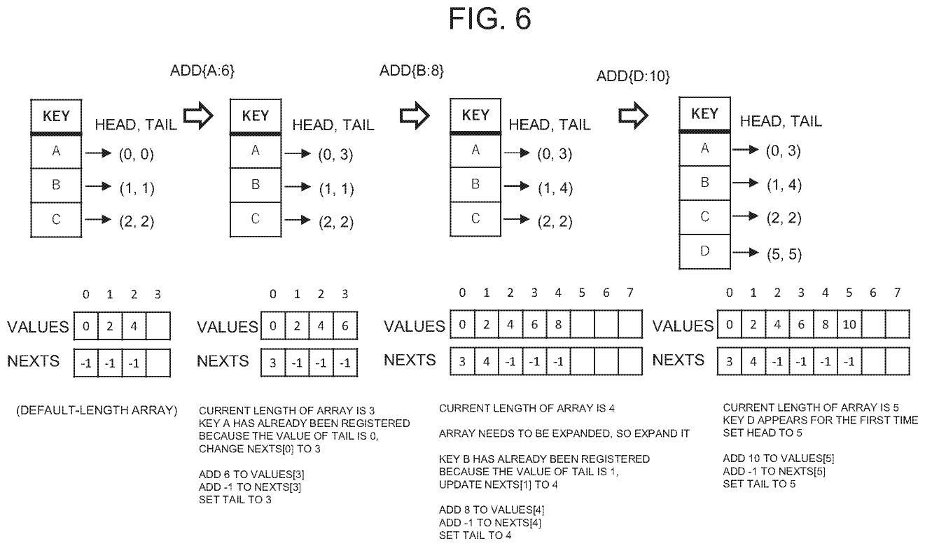

Next, the following explains an outline of an operation of the data management apparatus 100 with reference to FIG. 5 and FIG. 6. It should be noted that FIG. 5 and FIG. 6 are explanatory diagrams for facilitating understanding of the outline of the operation of the data management apparatus 100. Therefore, the configuration and operation of the data management apparatus 100 are not limited to those shown in FIG. 5 and FIG. 6.

In the examples shown in FIG. 5 and FIG. 6, a state of the hash table transitions from a left side to a right side of the drawings. A left side of FIG. 5 shows a hash table in an initial state in which no entry has yet been stored, and the hash table is created by the creation unit 111 of the data management apparatus 100. This hash table includes a values array and a nexts array each having a default length, that is, four elements in this example.

In the examples of FIG. 5 and FIG. 6, in the initial state, the hash table management unit 110 receives an addition request for adding a set of a Key “A” and a value “0” to the hash table. When receiving the addition request, the addition unit 112 acquires “0”, which is an effective length of the values array at the reception time, that is, a leading index of an unused element.

Key “A” is a Key that appears in the hash table for a first time. Therefore, the addition unit 112 sets the leading index of the unused element, that is, “0”, in head information associated with the Key “A”.

Further, the addition unit 112 stores the value “0” in values[0] and stores the specific value “−1” indicating an end in nexts[0]. Then, the addition unit 112 sets the index “0” in tail information associated with the Key “A”.

Next, the hash table management unit 110 receives an addition request for adding a set of a Key “B” and a value “2” to the hash table. When receiving the addition request, the addition unit 112 acquires “1”, which is an effective length of the values array at the reception time, that is, a leading index of an unused element.

The Key “B” is a Key that appears in the hash table for a first time. Therefore, the addition unit 112 sets the leading index of the unused element, that is, “1”, in head information associated with the Key “B”.

Further, the addition unit 112 stores the value “2” in values[1] and stores the specific value “−1” indicating an end in nexts[1]. Then, the addition unit 112 sets the index “1” in tail information associated with the Key “B”.

Next, the hash table management unit 110 receives an addition request for adding a set of a Key “C” and a value “4” to the hash table. When receiving the addition request, the addition unit 112 acquires “2”, which is an effective length of the values array at the reception time, that is, a leading index of an unused element.

The Key “C” is a Key that appears in the hash table for a first time. Therefore, the addition unit 112 sets the leading index of the unused element, that is, “2”, in head information associated with the Key “C”.

Further, the addition unit 112 stores the value “4” in values[2] and stores the specific value “−1” indicating an end in nexts[2]. Then, the addition unit 112 sets the index “2” in tail information associated with the Key “C”.

Next, as shown in FIG. 6, the hash table management unit 110 receives an addition request for adding a set of a Key “A” and a value “6” to the hash table. When receiving the addition request, the addition unit 112 acquires “3”, which is an effective length of the values array at the reception time, that is, a leading index of an unused element.

The Key “A” is a Key existing in the hash table. Therefore, the addition unit 112 refers to tail information associated with the Key “A” and acquires an index “0” indicating an element in which a last value associated with the Key “A” is stored. Subsequently, the addition unit 112 updates nexts[0] to the index “3”.

Further, the addition unit 112 stores the value “6” in values[3] and stores the specific value “−1” indicating an end in nexts[3]. Then, the addition unit 112 sets the index “3” in tail information associated with the Key “A”.

Next, the hash table management unit 110 receives an addition request for adding a set of a Key “B” and a value “8” to the hash table. When receiving the addition request, the addition unit 112 acquires “4”, which is an effective length of the values array at the reception time, that is, a leading index of an unused element.

Because the effective length of the values array has reached the capacity of the values array, the addition unit 112 executes expansion processing for the values array and the nexts array. In this example, the addition unit 112 expands the values array and the nexts array to double the existing size, that is, eight elements.

The Key “B” is a Key existing in the hash table. Therefore, the addition unit 112 refers to tail information associated with the Key “B” and acquires an index “1” indicating an element in which a last value associated with the Key “B” is stored. Subsequently, the addition unit 112 updates nexts[1] to the index “4”.

Further, the addition unit 112 stores the value “8” in values[4] and stores the specific value “−1” indicating an end in nexts[4]. Then, the addition unit 112 sets the index “4” in tail information associated with the Key “D”.

Next, the hash table management unit 110 receives an addition request for adding a set of a Key “D” and a value “10” to the hash table. When receiving the addition request, the addition unit 112 acquires “5”, which is an effective length of the values array at the reception time, that is, a leading index of an unused element.

The Key “D” is a Key that appears in the hash table for a first time. Therefore, the addition unit 112 sets the leading index of the unused element, that is, “5”, in head information associated with the Key “D”.

Further, the addition unit 112 stores the value “10” in values[5] and stores the specific value “−1” indicating an end in nexts[5]. Then, the addition unit 112 sets the index “5” in tail information associated with the Key “D”.

### Explanation of Effects

Next, the following explains effects of the present example embodiment. In the present example embodiment, the hash table management unit 110 manages data by using a hash table that holds a values array, that is, a first array, storing one or more values associated with each of a plurality of keys, a nexts array, that is, a second array, having elements respectively associated with elements of the values array and storing information indicating a storage location of a next value associated with a same key, and, for each of the plurality of keys, head information, that is, first information, indicating a storage location of a first value among the one or more values associated with the key, and tail information, that is, second information, indicating a storage location of a last value among the one or more values associated with the key.

Further, based on an addition request for a set of a key and a value, the addition unit 112 stores the value in a first-position element among unused elements of the values array. Further, the addition unit 112 stores, in an element of the nexts array associated with an element of the values array that stores the value of the addition request, information indicating that a next value is not stored. Further, when the key of the addition request does not exist in the hash table, the addition unit 112 respectively sets information indicating a storage location of the value of the addition request as head information and tail information. On the other hand, when the key of the addition request exists in the hash table, the addition unit 112 updates an element of the nexts array identified by tail information associated with the key to information indicating a storage location of the value of the addition request. Further, after updating the element of the nexts array, the addition unit 112 updates the tail information to information indicating a storage location of the value of the addition request.

Further, the acquisition unit 113 refers to head information associated with a key included in an acquisition request and acquires an index indicating an element in the values array in which a first value associated with the Key is stored. Thereafter, the acquisition unit 113 refers to an element of the values array associated with the acquired index and acquires a value stored in the element. Subsequently, the acquisition unit 113 refers to an element of the nexts array associated with the same index and acquires an index indicating an element in the values array in which a next value associated with the same key is stored.

With such a configuration, the data management apparatus 100 can manage one or more values associated with each of the plurality of Keys by using only a limited number of arrays, that is, the values array and the nexts array. That is, because the number of arrays does not increase in proportion to the number of Keys, it is possible to reduce memory management cost.

Each function, that is, each process, in the above example embodiment can be achieved by a computer having a processor, a memory, and the like. For example, a storage device, that is, a storage medium, may store a program for carrying out the method, that is, the processing, in the above example embodiment, and each function may be achieved by causing a processor to execute the program stored in the storage device.

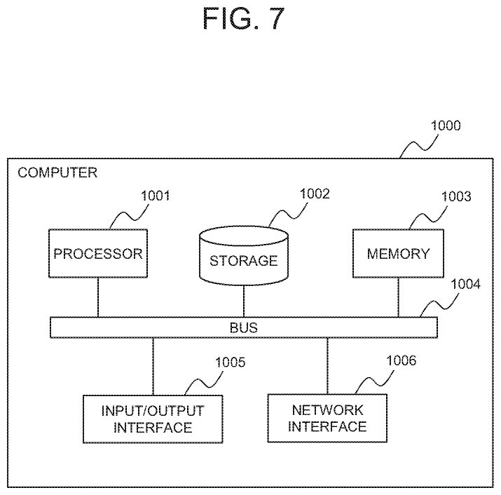

FIG. 7 is a block diagram illustrating a hardware configuration of a computer 1000. The computer 1000 is any computer. For example, the computer 1000 is a stationary computer such as a personal computer or a server machine. Further, for example, the computer 1000 is a portable computer such as a smartphone or a tablet terminal. The computer 1000 may be a dedicated computer designed to achieve the data management apparatus 100, or may be a general-purpose computer.

The computer 1000 includes a processor 1001, a storage device 1002, a memory 1003, a bus 1004, an input and output interface 1005, and a network interface 1006.

The processor 1001 is various processing devices such as a CPU (Central Processing Unit), a GPU (Graphics Processing Unit), an FPGA (Field-Programmable Gate Array), and a DSP (Digital Signal Processor).

The storage device 1002 is, for example, a non-transitory computer readable medium. The non-transitory computer readable medium includes various types of tangible storage media. Specific examples of the non-transitory computer readable medium include semiconductor memory such as mask ROM, PROM (Programmable ROM), EPROM (Erasable PROM), and flash ROM.

The memory 1003 is a main storage device implemented by using RAM (Random Access Memory) or the like. The memory 1003 temporarily stores data when the processor 1001 executes processing.

The bus 1004 is a data transmission path through which the processor 1001, the memory 1003, the storage device 1002, the input and output interface 1005, and the network interface 1006 transmit and receive data to and from each other. However, a method of connecting the processor 1001 and the like to each other is not limited to bus connection.

The input and output interface 1005 is an interface for connecting the computer 1000 and input and output devices. For example, an input device such as a keyboard and an output device such as a display device are connected to the input and output interface 1005.

The network interface 1006 is an interface for connecting the computer 1000 to a network. This network may be a LAN (Local Area Network) or may be a WAN (Wide Area Network).

The storage device 1002 stores a program for achieving the respective functional constituent units in the above example embodiment and example. By reading this program into the memory 1003 and executing the program, the processor 1001 achieves the respective functional constituent units in the above example embodiment and example.

The data management apparatus 100 may be achieved by one computer 1000 or may be achieved by a plurality of computers 1000. In the latter case, configurations of the respective computers 1000 need not be identical and may be different from each other.

The respective functional constituent units in the above example embodiment and example may be achieved by a combination of the above-described hardware and software, or may be achieved by hardware, for example, a hard-wired electronic circuit.

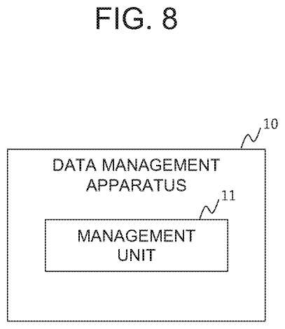

Next, the following explains an outline of the present disclosure. FIG. 8 is a block diagram showing an outline of a data management apparatus. A data management apparatus 10 according to the present disclosure, for example, corresponding to the data management apparatus 100, includes a management unit 11, implemented by the hash table management unit 110 in the example embodiment, configured to manage data by using a hash table that holds a first array, for example, a values array, storing one or more values associated with each of a plurality of keys, a second array, for example, a nexts array, having elements respectively associated with elements of the first array and storing information, for example, an index, indicating a storage location of a next value associated with a same key, and, for each of the plurality of keys, first information, for example, head information, indicating a storage location of a first value among the one or more values associated with the key, and second information, for example, tail information, indicating a storage location of a last value among the one or more values associated with the key. With such a configuration, because the number of arrays does not increase in proportion to the number of Keys and one or more values associated with each of the plurality of Keys can be managed by using only a limited number of arrays, it is possible to reduce memory management cost.

The present disclosure has been explained above with reference to example embodiments. However, the present disclosure is not limited to the above example embodiments. Various changes that can be understood by those skilled in the art can be made to the configuration and details of the present disclosure within a scope of the present disclosure. The respective example embodiments can be combined with other example embodiments as appropriate.

Each drawing is merely an example for explaining one or more example embodiments. Each drawing is not associated only with one specific example embodiment and may also be associated with one or more other example embodiments. As can be understood by those skilled in the art, various features or steps explained with reference to any one drawing can be combined with features or steps shown in one or more other drawings, for example, in order to create example embodiments that are not explicitly illustrated or explained. Not all features or steps shown in any one drawing for explaining exemplary example embodiments are necessarily essential, and some features or steps may be omitted. An order of steps described in any drawing may be changed as appropriate.

A part or all of the above example embodiment may also be described as in the following Supplementary notes, but is not limited thereto.

### Supplementary Note 1

A data management apparatus including:
a management unit configured to manage data by using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

### Supplementary Note 2

The data management apparatus according to Supplementary note 1, wherein
the management unit includes an addition unit configured to, based on an addition request for a set of a key and a value, store the value in a first-position element among unused elements of the first array.

### Supplementary Note 3

The data management apparatus according to Supplementary note 2, wherein
the addition unit is configured to store, in an element of the second array associated with an element of the first array that stores the value of the addition request, information indicating that a next value is not stored.

### Supplementary Note 4

The data management apparatus according to Supplementary note 2 or Supplementary note 3, wherein
when the key of the addition request does not exist in the hash table, the addition unit is configured to respectively set information indicating a storage location of the value of the addition request as the first information and the second information.

### Supplementary Note 5

The data management apparatus according to any one of Supplementary notes 2 to 4, wherein
when the key of the addition request exists in the hash table, the addition unit is configured to update an element of the second array identified by the second information associated with the key to information indicating a storage location of the value of the addition request.

### Supplementary Note 6

The data management apparatus according to Supplementary note 5, wherein
when the key of the addition request exists in the hash table, the addition unit is configured to update an element of the second array identified by the second information associated with the key and thereafter update the second information to information indicating a storage location of the value of the addition request.

### Supplementary Note 7

The data management apparatus according to any one of Supplementary notes 1 to 6, wherein
the management unit includes an acquisition unit configured to acquire a value associated with a specific key from the hash table.

### Supplementary Note 8

The data management apparatus according to any one of Supplementary notes 1 to 7, further including a creation unit configured to create the hash table.

### Supplementary Note 9

A data management method, performed by a computer and including:
managing data by using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

### Supplementary Note 10

A data management program for causing a computer to execute management processing for:
managing data by using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

### Supplementary Note 11

A non-transitory computer-readable storage medium storing a data management program that, when executed by one or more processors, causes the one or more processors to:
manage data by using a hash table that holds a first array storing one or more values associated with each of a plurality of keys, a second array having elements respectively associated with elements of the first array and storing information indicating a storage location of a next value associated with a same key, and, for each of the plurality of keys, first information indicating a storage location of a first value among the one or more values associated with the key, and second information indicating a storage location of a last value among the one or more values associated with the key.

Further, a part or all of the configurations described in Supplementary notes 2 to 8 that depend on the above Supplementary note 1 may also depend on Supplementary note 9, Supplementary note 10 and Supplementary note 11 by dependency relationships similar to those of Supplementary notes 2 to 8. Further, not limited to Supplementary note 1, Supplementary note 9, Supplementary note 10, and Supplementary note 11, within a range not departing from the above-described example embodiments, a part or all of the configurations described in the Supplementary notes may similarly depend on various kinds of hardware, software, various recording means for recording software, or systems.

1. A data management apparatus comprising:
a memory storing software instructions; and
one or more processors configured to execute the software instructions to:
manage data by using a hash table, the hash table comprising:
a first array storing one or more values associated with each of a plurality of keys;
a second array having elements respectively associated with elements of the first array and storing information indicating a storage location of a next value associated with a same key; and
for each of the plurality of keys, first information indicating a storage location of a first value among the one or more values associated with the key, and second information indicating a storage location of a last value among the one or more values associated with the key.

2. The data management apparatus according to claim 1, wherein
the one or more processors are further configured to, based on an addition request for a set of a key and a value, store the value in a first-position element among unused elements of the first array.

3. The data management apparatus according to claim 2, wherein
the one or more processors store, in an element of the second array associated with the element of the first array that stores the value of the addition request, information indicating that a next value is not stored.

4. The data management apparatus according to claim 3, wherein
when the key of the addition request does not exist in the hash table, the one or more processors respectively set information indicating a storage location of the value of the addition request as the first information and the second information.

5. The data management apparatus according to claim 4, wherein
when the key of the addition request exists in the hash table, the one or more processors update an element of the second array identified by the second information associated with the key to information indicating a storage location of the value of the addition request.

6. The data management apparatus according to claim 5, wherein
when the key of the addition request exists in the hash table, the one or more processors update an element of the second array identified by the second information associated with the key and thereafter update the second information to information indicating a storage location of the value of the addition request.

7. The data management apparatus according to claim 1, wherein
the one or more processors are further configured to acquire a value associated with a specific key from the hash table.

8. The data management apparatus according to claim 1, wherein
the one or more processors are further configured to execute the software instructions to:
create the hash table.

9. A data management method, performed by a computer and comprising:
managing data by using a hash table, the hash table comprising:
a first array storing one or more values associated with each of a plurality of keys;
a second array having elements respectively associated with elements of the first array and storing information indicating a storage location of a next value associated with a same key; and
for each of the plurality of keys, first information indicating a storage location of a first value among the one or more values associated with the key, and second information indicating a storage location of a last value among the one or more values associated with the key.

10. A non-transitory computer-readable storage medium storing a data management program that, when executed by one or more processors, causes the one or more processors to:
manage data by using a hash table, the hash table comprising:
a first array storing one or more values associated with each of a plurality of keys;
a second array having elements respectively associated with elements of the first array and storing information indicating a storage location of a next value associated with a same key; and
for each of the plurality of keys, first information indicating a storage location of a first value among the one or more values associated with the key, and second information indicating a storage location of a last value among the one or more values associated with the key.

11. The data management apparatus according to claim 2, wherein
when the key of the addition request does not exist in the hash table, the one or more processors respectively set information indicating a storage location of the value of the addition request as the first information and the second information.

12. The data management apparatus according to claim 2, wherein
when the key of the addition request exists in the hash table, the one or more processors update an element of the second array identified by the second information associated with the key to information indicating a storage location of the value of the addition request.

13. The data management apparatus according to claim 3, wherein
when the key of the addition request exists in the hash table, the one or more processors update an element of the second array identified by the second information associated with the key to information indicating a storage location of the value of the addition request.

14. The data management apparatus according to claim 11, wherein
when the key of the addition request exists in the hash table, the one or more processors update an element of the second array identified by the second information associated with the key to information indicating a storage location of the value of the addition request.
